(19) United States
(12) Patent Application Publication
(10) Pub. No.: US 2021/0049856 A1
(43) Pub. Date: Feb. 18, 2021

(54) SOLAR POWERED VENDING MACHINE

(71) Applicant: Hidden Water LLC, North Palm Beach, FL (US)

(72) Inventors: Jeffrey Quinton Irish, North Palm Beach, FL (US); Jay Sussman, Lake Worth, FL (US)

(21) Appl. No.: 16/992,637

(22) Filed: Aug. 13, 2020

Related U.S. Application Data
(60) Provisional application No. 62/885,942, filed on Aug. 13, 2019.

(51) Int. Cl. G07F 11/32; F25D 31/00; F25D 23/06; G06Q 20/18; G06Q 20/34; H02S 10/40; H02S 40/38

(52) U.S. Cl. CPC G07F 11/32; F25D 31/007; F25D 23/06; F25D 2201/126; G06Q 20/34; H02S 10/40; H02S 40/38; G06Q 20/18

(57) ABSTRACT

A vending device is portable and employs a solar powered system for use in cooling and dispensing water sold in cans. The device includes a rotomolded insulated housing with an internal stand for receipt of cartridges used in storing and dispensing of the canned water. Dispensing of a can is by use of a cashless payment system accepting phone app, credit/debit cards for interacting with a controller for operating of a linear actuator for releasing a can. Angled cartridges and a ramped bottom panel employ gravity for movement to minimize power consumption. A low profile allows the device to be easily camouflaged.

### PRIORITY CLAIM

In accordance with 37 C.F.R. § 1.76, a claim of priority is included in an Application Data Sheet filed concurrently herewith. Accordingly, the present invention is a continuation application and claims priority to U.S. Provisional Patent Application No. 62/885,942, entitled “STACKABLE AND CAMOUFLAGED SOLAR POWERED VENDING MACHINE”, filed Aug. 13, 2019. The contents of the above referenced application are incorporated herein by reference.

### FIELD OF THE INVENTION

The present invention relates to vending machines and, more particularly, a stackable and camouflaged solar powered vending machine.

### BACKGROUND OF THE INVENTION

Vending machines are unsightly, bulky, difficult to transport, and must be plugged into an electrical socket under shelter. Known vending machines are large and focused on attracting attention with bright commercial lights that can easily distract from the immediate environment that may otherwise be picturesque. They are further complicated by providing a variety of drinks requiring complicated, and power consuming, electro/mechanical elements.

For example, current vending machines are only found in selected areas of a public park, as the large commercial advertising would distract from an otherwise beautiful environment. However, while most vending machines are focused on selling soft drinks, many areas, such as a public park, cater to healthy individuals who are simply in need of water. Thus, while a public park is designed to allow individuals to roam freely and enjoy the outdoors, humans require water to avoid dehydration. In this example, the placement of a conventional vending machine near a scenic section of a park would be most distracting to the natural beauty of the park. Further, conventional vending machines require an electrical source by either unsightly above ground wires or burying of unground wires.

By way of another example, individuals playing golf require water to hydrate, especially on days with high temperatures, as the golfers exert great effort in advancing of the golf ball. Every golf course has eighteen tee boxes, which are the starting point of every hole on a golf course. Placing conventional vending machines at each tee box would be most distracting to an otherwise pristinely manicured course and again require electricity where none is common. For this reason, water coolers are commonly found every few holes. A water cooler typically consists of a plastic container holding gallons of water, and is typically situated next to a tank filled with ice. Unfortunately, water coolers and ice containers are breeding grounds for bacteria, as the containers sit in the sun for long periods of time and the dispensers are handled by every golfer who needs fluids. During the Covid-19 pandemic, use of coolers has been prohibited, requiring the golfer to search for water. This can be especially problematic during golf tournaments where water consumption is at a peak demand. While parks and golf courses are provided as examples, the need for safe water is needed in countless settings, such as athletic events including marathons, soccer matches, and the like events that are periodic events, making them impractical for conventional long term vending machines. Portable coolers have the advantage of portability, but lack the ability to charge consumers for receipt of cold drinks.

What is needed in the industry is a portable cooler having the attributes of a vending machine in that it is portable, solar powered, and easily transported to provide safe and cold water where needed. The vending machine would benefit by use of a low profile that can provide a camouflaged exterior so as not to distract from local settings.

### SUMMARY OF THE INVENTION

Disclosed is a solar powered, portable vending machine to provide safe, cold water. The vending machine includes an enclosure designed to blend in with a particular environmental setting. The enclosure accepts payment by phone app, credit/debit cards or the like; the elimination of cash simplifying the mechanics. In one embodiment, the instant vending machine dispenses water in a can using eight quick release cartridges that hold about 22 cans per cartridge, providing 176 servings. The vending machine provides a single position for dispensing; the internals of the vending machine are not accessible by the consumer. All components are modular, and service through a hinged lid allows ease of access. Solar panels are embodied into the enclosure lid. A solar panel is electrically coupled to a rechargeable battery and constructed and arranged to provide power to a cooling system, allowing the vending machine to be readily moved into areas that have no power or choose to be environmentally friendly. Wireless inventory instructs when the vending machine is to be replenished.

An objective of the instant invention is to provide a portable solar powered vending machine for dispensing of water, wherein the vending machine can be placed in environmentally sensitive areas.

Another objective of the invention is to provide a low profile horizontal designed vending machine that is designed to accept different facades to be camouflaged or blend in with a particular environment. External facades include wraps which look like bricks, boxwood, bark, sandblasted surface and so forth.

Still another objective of the invention is to provide a vending machine with a cartridge loading wherein 22 or more cans can be replenished to decrease restocking time.

Another objective of the invention is to provide a vending machine having a rotomolded double walled insulated housing with a sloped dispensing surface for gravity movement of cans to a single dispensing point.

Still another objective of the invention is to provide a vending machine having an Arduino Board using open source hardware and software coding language.

Yet still another objective of the invention is to provide a convex solar panel that is bent to face North, South, East and West.

Still another objective of the invention is to limit the receptacle volume to be cooled to a minimum, allowing the use of a small conventional cooling compressor, wherein power received from solar panels is sufficient.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a perspective view of an exemplary embodiment of the present invention;

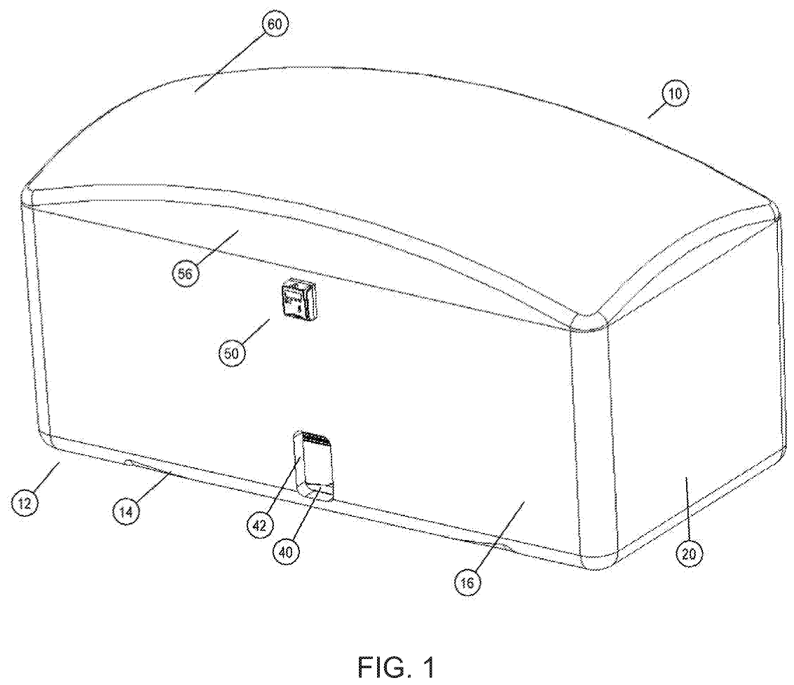

FIG. 2 is an exploded view thereof;

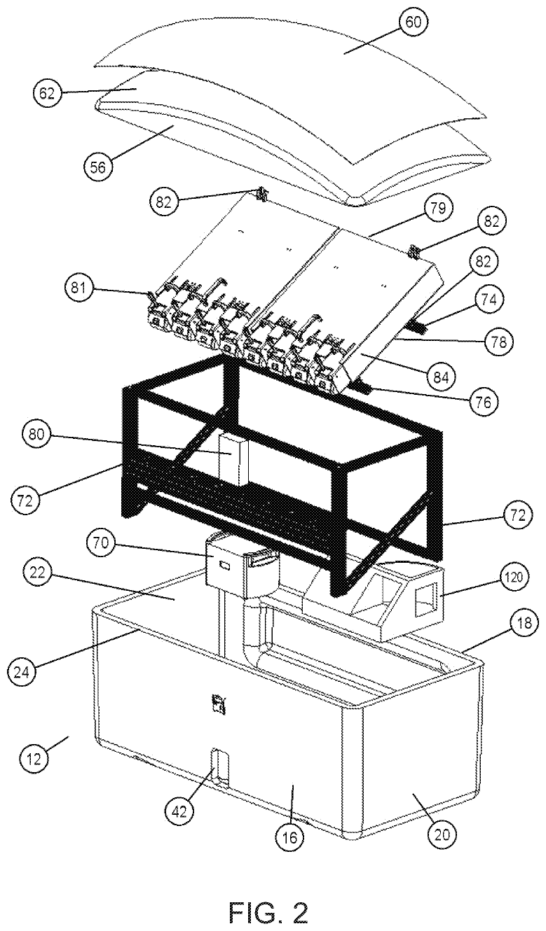

FIG. 3 is a cross-sectional view;

FIG. 4 is a perspective view of the cartridge support housing with four cartridges;

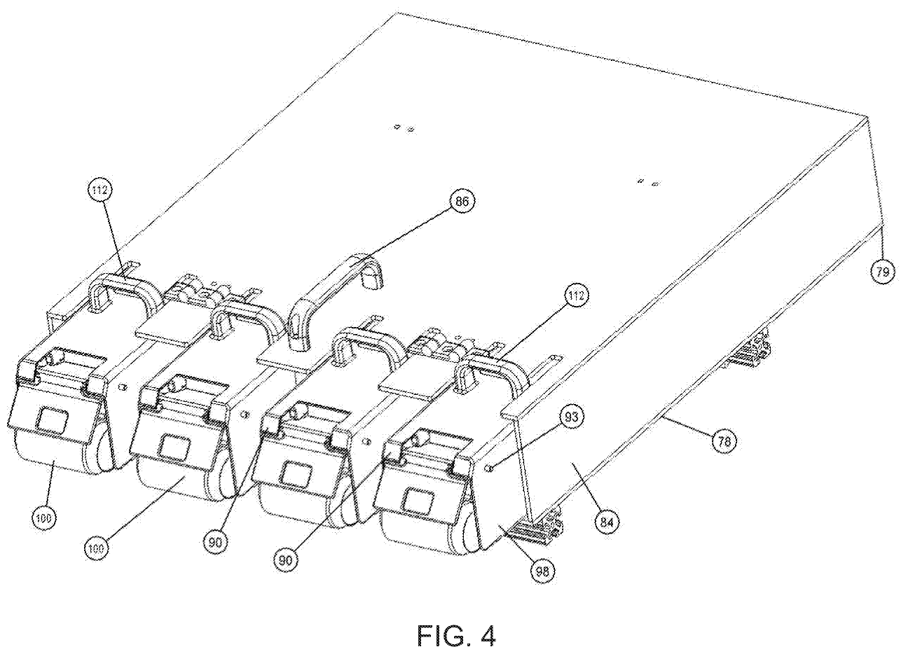

FIG. 5 is a perspective view of the cartridge support housing with two cartridges;

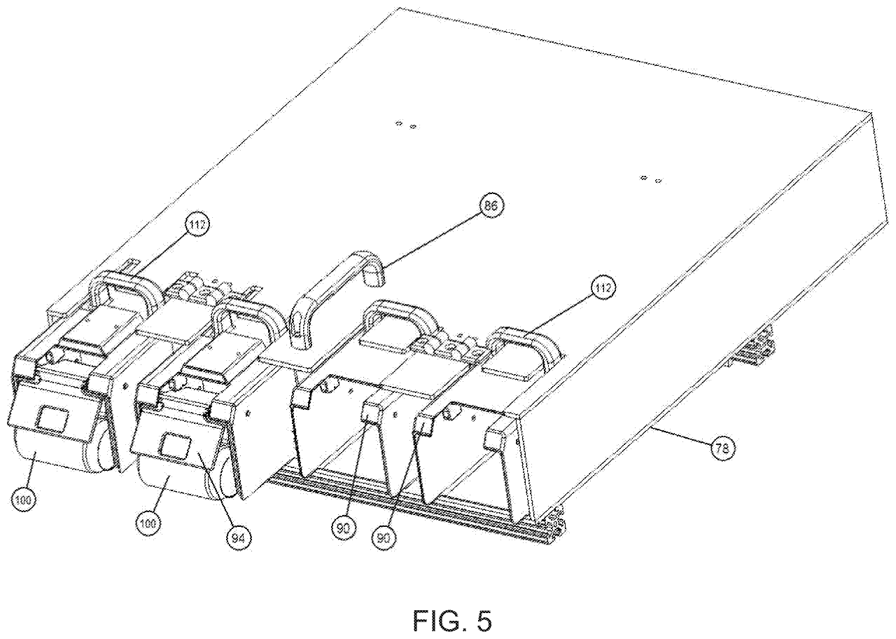

FIG. 6 is an enlarged perspective view illustrating the two cartridges of FIG. 5;

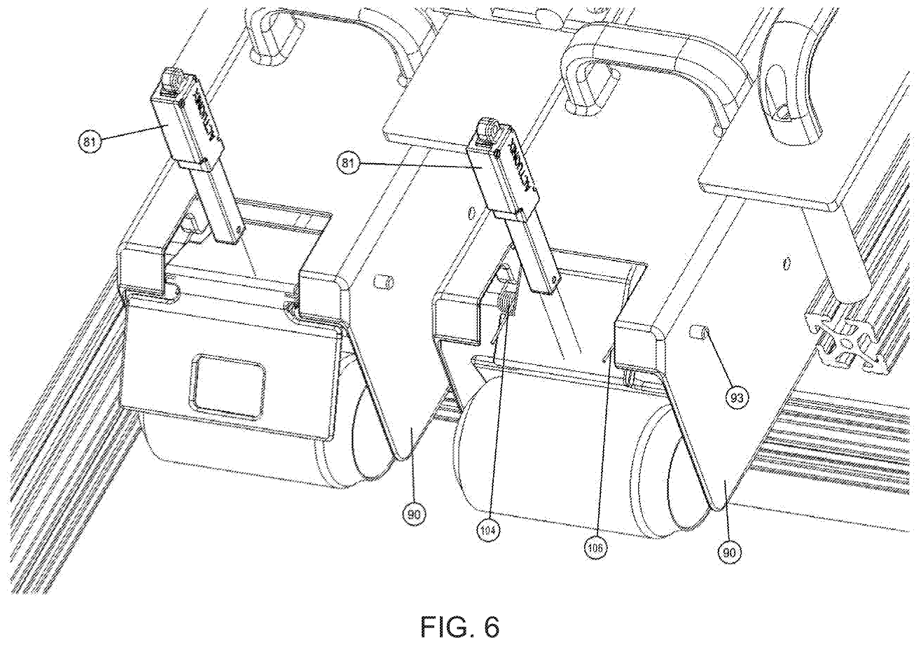

FIG. 7 is a perspective view of the paddle arm;

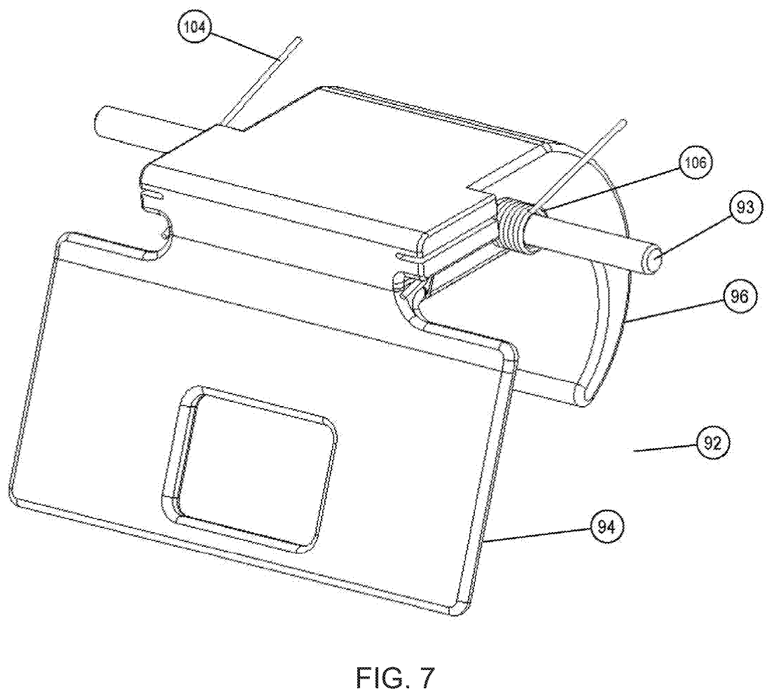

FIG. 8 is a cross-sectional view of a cartridge holding twenty-two cans;

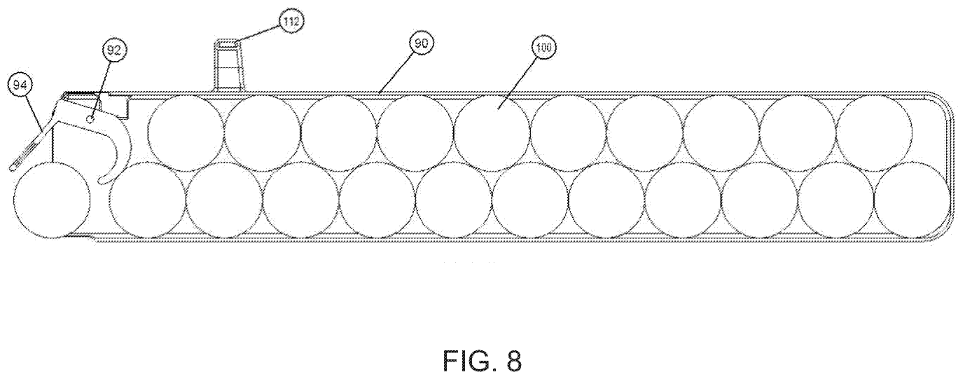

FIG. 9 is a top perspective view of the housing;

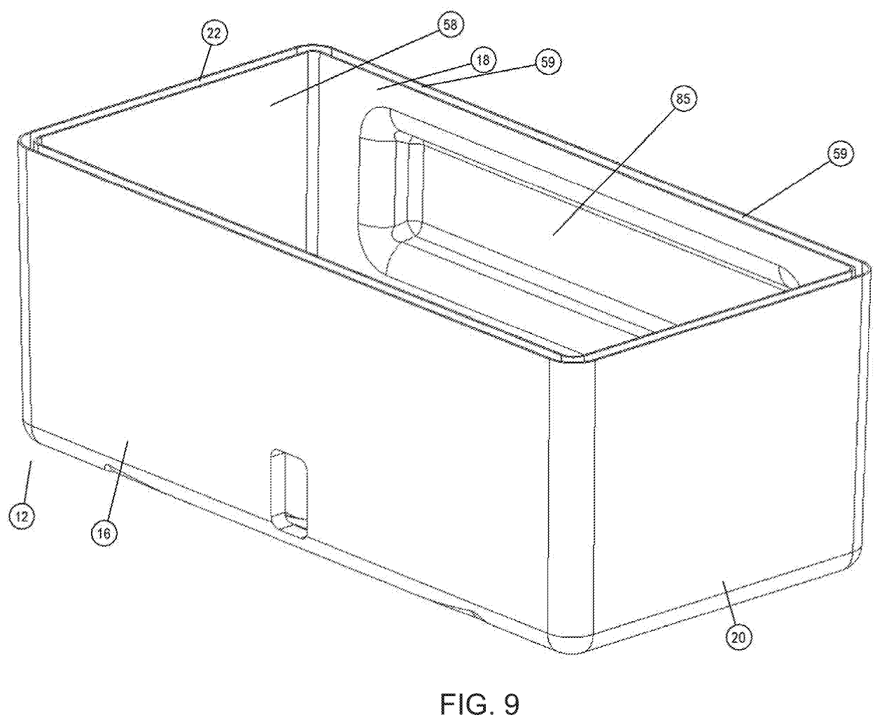

FIG. 10 is a bottom perspective view of the housing; and

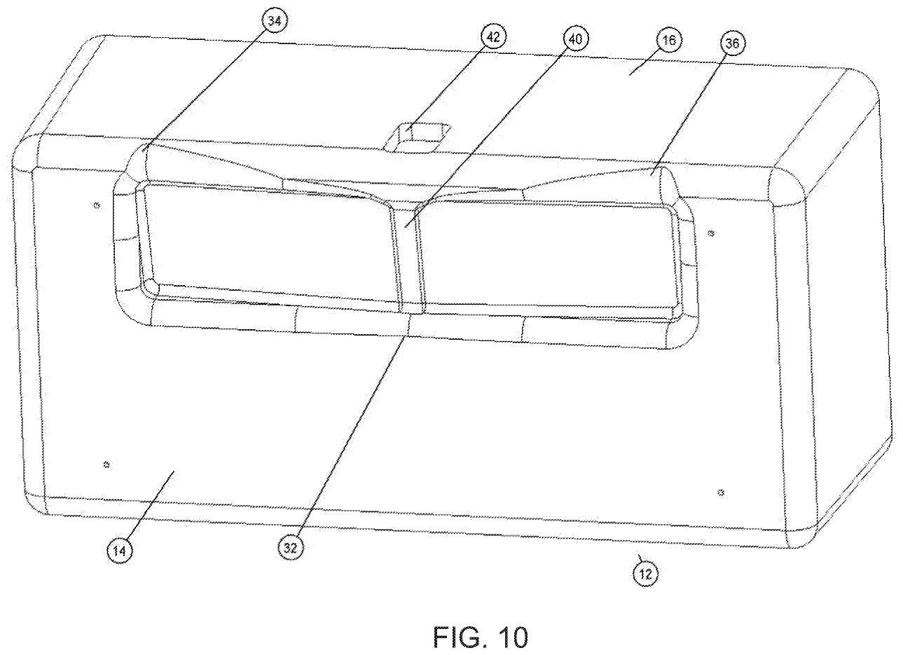

FIG. 11 is a cross-sectional view of the housing.

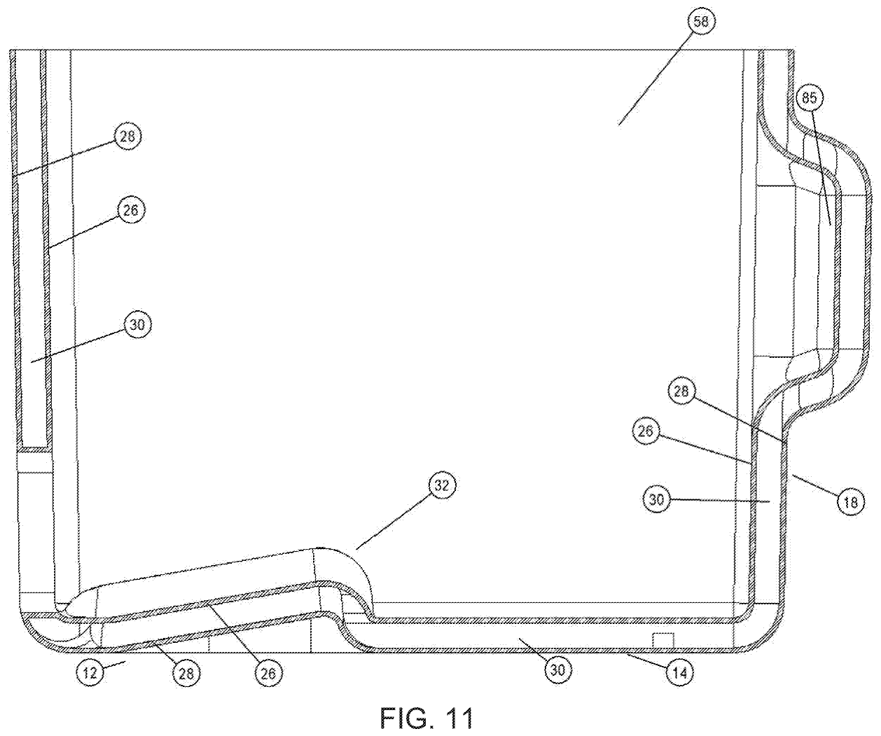

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the present invention.

Referring to the Figures in general, illustrated is a perspective view of the vending device 10 having a base housing 12 formed from a bottom panel 14, a front panel 16, a rear panel 18, two side panels 20, 22, and an open top 24. The housing 12 is rotomolded, having an inner shell wall 26 spaced apart from an outer shell wall 28 with a layer of foam 30 therebetween. The layer of foam 30 is selected from the group consisting of polyfoam, polyurethane, polyethylene or a blend of polyurethane or polyethylene.

The bottom panel 14 has a ramp 32 with a slope having elevated sections 34, 36 leading to a centrally disposed lower positioned dispensing area 40. The front 16 wall includes an aperture 42 to coincide with the centrally disposed lower dispensing area 40. The lower dispensing area 40 and said ramp are coated with a resilient polymer to provide sound dampening for cans that roll down the ramp and settle in the dispensing area. The vending device 10 is for use in dispensing water or the like non-carbonated flavored water, such a Gatorade®, wherein the rolling down a ramp of a carbonated fluid is not desired.

A card reader 50 is mounted to the front panel 16 to provide a cashless point of sale terminal. The card reader 50 accepts magnetic swipe, contact and contactless operation, and in a preferred embodiment incorporates the NAYAX terminal. Payment methods include credit/debit cards, mobile NFC payments, prepaid cards and QR cards.

A lid 56 encloses the housing 12, forming a receptacle 58 therein. The lid 56 is hinged 59 and attached to the rear panel 18 for pivoting between an open position for access to the receptacle 58 through the open top 24 to a closed position for sealing the receptacle 58. The lid 56 is magnetically attracted to the housing 12 for holding the lid assembly in a releasably closed position. The lid 56 cannot be opened by the consumer, as the lid 56 is only to be opened by service personnel for purposes of restocking or service.

A solar panel 60 is secured to an upper surface 62 of the lid 56. The upper surface 62 is convex shaped for receipt of a flexible solar panel, the convex shape allowing the solar panel 60 to receive sunlight when the sun is in the east, west, south, and north direction.

A rechargeable battery 70 is positioned within the receptacle 58 and electrically coupled to the card reader 50 and the solar panel 60 through a control board 80 to cartridge linear actuators 81 and the cooling system 120.

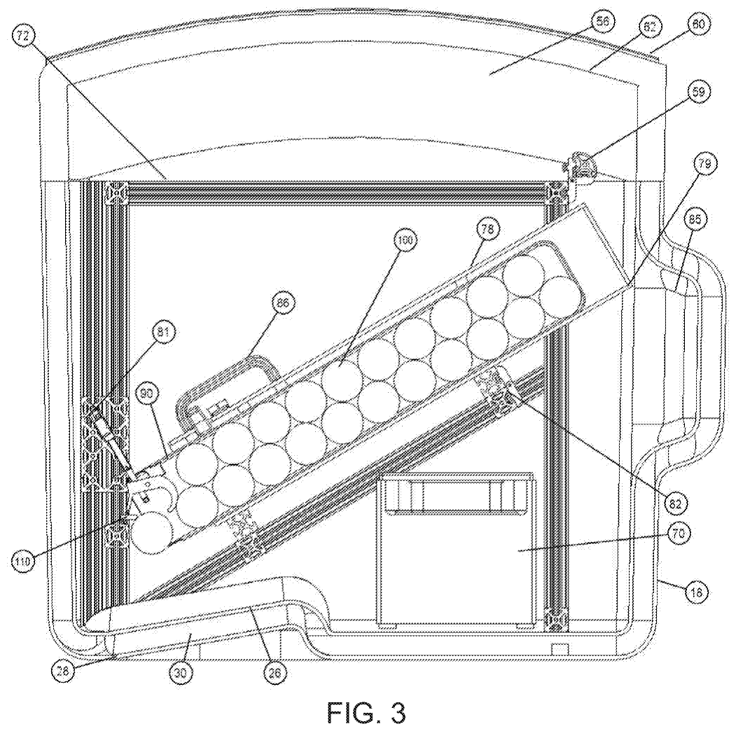

A frame 72 is constructed and arranged to fit within said receptacle 58, the frame 72 having pivot support 74 at a position above a cartridge support 76. A cartridge housing 78 includes hinges 82 secured to the pivot support 74, allowing a loading end 84 to be rotated from a dispensing position wherein the loading end 84 rests on top of the cartridge support 76 to a service position, wherein the loading end 84 is rotated to a position about the pivot support 74 for ease of access. The cartridge housing 78 has a handle 86 for ease of lifting the loading end 84 into the raised position. The cartridge housing 78 includes a plurality of individual cartridges 90 each having a linear actuator 81 which is controlled through the control board 80. Each linear actuator 81 is attached to the frame 72 and positioned above the cartridge housing 78. A paddle 92 is attached to each cartridge housing; the paddle 92 is further defined by a paddle restrictor 94 and a curved paddle cam 96. Each paddle 92 is secured to the end 98 of the cartridge 90, having an axle pin 93 as a pivot point which is biased in position by springs 104 and 106 to capture individual cans 100. The curved paddle arm 96 essentially blocks cans fed by gravity with the paddle restrictor 94, allowing a single can 100 to pass. Once the can 100 has passed, the springs 104 and 106 return the paddle arm 96 to a blocking position to minimize the amount of power needed to dispense a can 100. It is noted that the cartridge housing 78, as illustrated in FIG. 3, is at a slope, allowing gravity feeding of cans without further consumption of power. In one embodiment, each cartridge 90 holds 22-12 oz cans and the housing holds eight cartridges or 176-12 oz cans. When the cartridge 90 is to be replenished, the lid 56 is opened and a service individual lifts the handle to the cartridge housing 78. The cartridge housing 78 rotates along hinge 82 with a distal end 79 of the cartridge housing 78 allowed to rotate within the receptacle 58 through a back panel 18 extension 85. An objective of the invention is to limit the receptacle 58 volume to be cooled to a minimum.

The control board 80 preferably includes an ARDUINO® chip powered by the battery 70 and interfaced with the card reader 50. When the card reader 50 receives and verifies payment, the control board 80 checks a sensor 110 which is positioned in front of the paddle 92 and attached to the frame. The sensor 110 determines if a can 100 is present and, if present, causes the linear actuator 81 to release the can 100; the sensors being the integration of optical and inductive sensors electrically coupled to the control board 80. When the can 100 is released, the can 100 will roll down the ramp to the dispensing area 40 where an individual may retrieve the dispensed can through the aperture 42. As the ramp is sloped, gravity allows the can to move from an elevated position to the lower positioned dispensing area 40. If no can 100 is present, the control board 80 will initiate a review of the adjoining cartridge 90. In the preferred embodiment, there are two cartridge housings 78, each having four (4) cartridges 90 housing about twenty-two (22) cans 100. When the controller 80 determines that only one cartridge 90 contains cans, the controller 80 informs the owner by wireless transmission of the need for restocking. For restocking, the lid 56 is raised and the cartridge housing 78 is rotated upward by lifting handle 86. The individual cartridges 90 are removed by grasping cartridge handle(s) 112 and pulling the cartridge 80 from the cartridge housing 78.

A cooling system 120 is positioned within the receptacle 58; the cooling system consisting of a conventional compressor and condenser sized to cool the receptacle using power from the battery 70. The small volume of space to be cooled and the highly efficient insulated housing 12 allows the cooling system 120 to operate solely from the battery 70 source as replenished by the solar panel 60. It is noted that the rotomolded housing with two shell walls 26 and 28, having insulation 30 therebetween, can keep the contents of the housing cool for long periods of time.

The vending device 10 is preferably camouflaged, wherein the insulated box, solar panels and battery, interior vending components, and cashless payment system are necessary to operate as the vending machine of the instant invention. The camouflaged exterior, whether it be a faux Boxwood plastic shrubbery or other camouflage, is optional.

The customer will address the unit, pay for items quickly via cashless payment and retrieve their purchase(s) from the dispensing location and leave. The unit ownership will be notified via wireless communication when inventory hits a threshold, allowing the owner to swap out the unit for a fully stocked unit, or simply replace the cartridges filled with cans.

One skilled in the art will readily appreciate that the present invention is well adapted to carry out the objectives and obtain the ends and advantages mentioned, as well as those inherent therein. The embodiments described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A vending device comprising:
a housing formed from a bottom panel, a front panel, a rear panel two side panels, and an open top; said bottom panel having a ramp with a slope having elevated sections leading to a centrally disposed lower positioned dispensing area; said front wall including an aperture formed in said front to coincide with said centrally disposed lower dispensing area;
a lid enclosing said housing forming a receptacle therein, said lid hingedly attached to said rear panel for pivoting between an open position for access to said receptacle to a closed position for sealing said receptacle;
a solar panel secured to an upper surface of said lid;
a rechargeable battery is positioned within said receptacle and electrically coupled to said solar panel;
a frame positionable within said receptacle;
a cartridge support housing pivotedly attached to said frame, said cartridge housing having a dispensing end rotatable between a lower position to allow gravity dispensing and a raised position to allow service access;
a plurality of cartridges releasably secured to said cartridge support housing, each said cartridge including a linear actuated paddle restrictor;
a card reader secured to said front panel and electrically coupled to said battery, said card reader interfacing with a micro controller for operating each said linear actuated paddle restrictor for dispensing of a can held by a cartridge upon demand;
a cooling device placed within said housing electrically coupled said rechargeable battery and said microcontroller;
wherein said cartridges are filled with fluid cans and dispensed upon payment through said card reader, a dispensed can released from said cartridge by said linear actuator and rolled to said dispensing point using gravity to roll down said ramp.

2. The vending device according to claim 1 wherein said panels are rotomolded having an inner shell wall spaced apart from an outer shell wall with a layer of foam therebetween.

3. The vending device according to claim 2 wherein said layer of foam is selected from the group consisting of polyfoam, polyurethane, polyethylene or a blend of polyurethane or polyethylene.

4. The vending device according to claim 1 wherein said ramp is formed integral to said bottom panel, said slope constructed and arranged to direct cans dropped thereon to roll from the elevated sections to said centrally disposed lower dispensing point.

5. The vending device according to claim 1 wherein said ramp and said lower dispensing point includes a resilient polymer to provide sound dampening.

6. The vending device according to claim 1 wherein said lid assembly is magnetically attracted to said base for holding said lid assembly in a releasably closed position.

7. The vending device according to claim 1 wherein said microcontroller includes an Arduino Chip.

8. The vending device according to claim 1 wherein said microcontroller receives data from optical and inductive sensors to detect paddle arm movement and can location.

9. The vending device according to claim 1 wherein said lid includes a convex upper surface for receipt of a flexible solar panel, said convex surface allowing said solar panel to receive sunlight from the east, west, south, and north positions.

10. The vending machine according to claim 1 wherein each said cartridge holds 22-12 ounce cans.

11. The vending machine according to claim 10 wherein said housing holds eight said cartridges or holds 176-12 ounce cans.

12. A vending device for dispensing of 12 ounce cans filled with water comprising:
a plastic housing formed from a bottom panel, a front panel, a rear panel, two side panels, and an open top; said bottom panel having a ramp with a slope having elevated sections leading to a centrally disposed lower positioned dispensing area, said panels are rotomolded having an inner shell wall spaced apart from an outer shell wall with a layer of foam therebetween, said front wall including an aperture formed in said front to coincide with said centrally disposed lower dispensing area, said lower dispensing point including a resilient polymer to provide sound dampening;
a plastic lid enclosing said housing forming a receptacle therein, said lid hingedly attached to said rear panel for pivoting between an open position for access to said receptacle to a closed position for sealing said receptacle, said lid having a convex upper surface;
a solar panel secured to an upper surface of said lid;
a rechargeable battery is positioned within said receptacle and electrically coupled to said solar panel;
a frame positionable within said receptacle;
a cartridge support housing pivotedly attached to said frame, said cartridge housing having a dispensing end rotatable between a lower position to allow gravity dispensing and a raised position to allow service access;
a plurality of cartridges releasably secured to said cartridge support housing, each said cartridge including a linear actuated paddle restrictor;
a card reader secured to said front panel and electrically coupled to said battery, said card reader interfacing with a micro controller for operating each said linear actuated paddle restrictor for dispensing of a can held by a cartridge upon demand;
a cooling device placed within said housing electrically coupled to said rechargeable battery and said microcontroller;
wherein said cartridges are filled with fluid cans and dispensed upon payment through said card reader, a dispensed can released from said cartridge by said linear actuated paddle restrictor and rolled to said dispensing point using gravity to roll down said ramp.

13. The vending device according to claim 12 wherein said ramp is formed integral to said bottom panel, said slope constructed and arranged to direct said cans dropped thereon to roll from the elevated sections to said centrally disposed lower dispensing point.

14. The vending device according to claim 12 wherein said lid assembly is magnetically attracted to said base for holding said lid assembly in a releasably closed position.

15. The vending device according to claim 12 wherein said microcontroller includes an Arduino Chip.

16. The vending device according to claim 12 wherein said microcontroller receives data from optical and inductive sensors to detect paddle arm movement and can location.

17. The vending device according to claim 12 wherein said solar panel is constructed and arranged to receive sunlight from the east, west, south, and north positions.

18. The vending machine according to claim 12 wherein each said cartridge holds 22-12 ounce cans.

19. The vending machine according to claim 18 wherein said housing holds eight said cartridges or holds 176-12 ounce cans.
